(19) United States
(12) Patent Application Publication
(10) Pub. No.: US 2005/0163696 A1
(43) Pub. Date: Jul. 28, 2005

(54) Synthesis of carbon nanotubes by making use of microwave plasma torch

(76) Inventors: Han Sup Uhm, Potomac, MD (US); Yong C. Hong, Inchen (KR)

Correspondence Address: Han Sup Uhm, 11613 Swains Lock Terrace, Potomac, MD, 20854, US

(21) Appl. No.: 10/765,171

(22) Filed: Jan. 28, 2004

(51) Int. Cl. B01J 19/08; B01J 19/12

(52) U.S. Cl. 423/445 B; 422/186.04

(57) ABSTRACT

The present invention relates to a synthesis method of carbon nanotubes, and more particularly to an apparatus for a mass synthesis of carbon nanotubes in gas phase using an atmospheric-pressure microwave plasma torch. The method and apparatus is described for the continuous production of carbon nanotubes by making use of a microwave plasma torch operated at a frequency of 2.45 GHz, by introducing a transition metal catalyst precursor and a carbon containing gas into the microwave plasma torch to produce atomized catalyst metal and to decompose the carbon containing gas, by passing the resulting gaseous mixtures through a furnace, and by quenching rapidly and collecting the products so formed at the exit of the furnace. The resultant products are the carbon nanotubes.

### REFERENCE CITED: U.S. PATENT DOCUMENTS

| | | |
|---|---|---|
| 5,137,701 | August 1992 | Mundt |
| 5,468,356 | November 1995 | Uhm |
| 5,505,909 | April 1996 | Dummersdorf et al |
| 5,830,328 | November 1998 | Uhm |
| 6,620,394 | September 2003 | Uhm et al |

### FIELD OF THE INVENTION

The present invention relates generally to a microwave plasma apparatus and a method for synthesis of carbon nanotubes using the microwave plasma torch, and more particularly a microwave plasma synthesis apparatus, which synthesizes continuously a large amount of carbon nanotubes in gas phase. The synthesized carbon nanotubes have an average diameter of 100 nm or less.

### BACKGROUND OF THE INVENTION

Carbon nanotubes were first introduced to the scientific community by Sumio lijima through a paper entitled “Helical microtubles of graphitic carbon”, Nature, vol. 354, Nov. 7, 1991, pp. 56-58. According to the paper, it was shown that a material containing carbon nanotubes of about 15% could be produced by arc discharge between graphite rods. Since the first discovery by Sumio Iijima, carbon nanostructures, and nanotubes in particular, are very promising candidates for a wide range of applications such as field emission devices, white light sources, hydrogen storage cells, lithium secondary batteries, transistors or cathode ray tubes (CRTs) because of their extraordinary electrical and mechanical properties. Low cost, high purity, high yield, and large scale production is very important for a broad range of carbon nanotube application. The presently-known techniques for carbon nanotube synthesis include an arc discharge method, laser ablation method, gas phase synthesis, thermal chemical-vapour deposition (CVD) method, plasma CVD method and the like.

In the arc discharge method [C. Journet et al., Nature, 388, 756 (1997) and D. S. Bethune et al., Nature, 363, 605 (1993)], typically a large current is passed between carbon electrodes, leading to the evaporation of carbon species in the high temperature discharge. Products may be deposited on the counter electrode or chamber walls. Single-wall nanotubes are grown through the introduction of catalyst metal powders (typically transition metals such as Ni, Co, or Y) into graphite electrodes. This method produces carbon nanotubes with a high crystallinity but the purity of the product may be low due to the instability of the arc and due to the non-uniformity of the growth conditions. In spite of motorized insertion of electrodes, this approach is essentially a batch or semi-auto process yielding only a few grams of material per run, with no prospect of improvement.

A high power laser in the laser ablation method [R. E. Smally et al., Science, 273, 483 (1996)], usually pulsed, or sometimes continuous is used to ablate a graphite target, containing metal catalyst particles, into an inert gas. Single-wall nanotubes condense from mixed carbon and metal vapour. This method can produce high quality material but the yields and overall energy efficiency are low. Non-uniform ablation of the target means that this approach must be run as a batch process. Moreover, excess amorphous carbon lumps are produced along with carbon nanotubes, and thus they need complicated purification processes.

The thermal CVD method for the carbon nanotube growth on a predetermined substrate involves a growing of carbon nanotubes over a porous silica [W. Z. Li et al., Science, 274, 1701 (1996)] or Zeolite [Shinohara et al., Japanese J. Appl. Phys., 37, 1357 (1998)] substrate. A carbon containing gas in this method is thermally decomposed using CVD to produce a carbon nanotube. It is possible to align carbon nanotubes vertically on a substrate and to grow the carbon nanotubes at lower temperature compared with the method using arc discharge and laser ablation. However, filling pores of the substrate with a metal catalyst is a complicated and time-consuming process. Thus, the thermal CVD method has a limitation in mass production of carbon nanotubes.

The plasma CVD at low pressures [Z. F. Ren et al., Science, 282, 1105 (1998)] is a suitable method for vertically aligned carbon nanotubes with excellent performance. However, there are problems related to the carbon nanotube damage by plasma energy and the structure of carbon nanotubes grown in plasma CVD chamber is unstable due to the synthesis process at low temperatures in comparison with those by the arc discharge method. Also, the plasma CVD method at low pressures has a limitation in mass production of carbon nanotubes.

Finally, the gas phase synthesis method [H. M. Cheng et al., Appl. Phys. Lett., 72, 3282 (1998) and R. Andrews et al., Chem. Phys. Lett., 303, 468, (1999)], which is appropriate for mass synthesis of carbon nanotubes, produces carbon nanotubes in a gas phase in a furnace without a preformed substrate.

The afore-mentioned synthesis methods, such as an arc discharge method, laser ablation method, thermal chemical vapour deposition (CVD) method, plasma CVD method, may not be the best methods for obtaining a continuous and mass production of carbon nanotubes on a commercial scale. High purity, high yield, and low-cost nanotube growth must be emphasized for a wide range application of carbon nanotubes.

### SUMMARY OF THE INVENTION

The present invention includes a synthesis method of carbon nanotubes, and more particularly to an apparatus for a mass synthesis of carbon nanotubes in gas phase using an atmospheric-pressure microwave plasma torch.

The present invention consists of the magnetrons used in home microwave ovens. These magnetrons are inexpensive, commercially available and compact. They are operated at a frequency of 2.45 GHz and have low power in the range of 0.6˜1.4 kW. Also, continuously variable magnetron having input power between 0.1˜6 kW is used in this invention. The microwave intensity with a frequency of 2.45 GHz from a magnetron is highest at the discharge tube. These intense microwaves at the discharge tube induce an intense electric field, initiating electrical breakdown in the carrier gas containing a carbon source gas and a transition metal catalyst precursor vaporized.

The plasma torch generated by the electrical breakdown due to the microwave electric field dissociates and ionizes the carrier gas containing a carbon source gas and a transition metal catalyst precursor vaporized by molecular breakdown and by hot gases. The chemically active species produced in the plasma torch is utilized to initiate a chemical reaction between various reactants in the plasma torch. The interaction between chemical species in the gas mixtures results in carbon nanotubes by passing them through a furnace with temperature in the range of 600˜1200° C. The furnace plays an important role in delaying reaction time of the chemical species and providing a synthetic environment of carbon nanotubes. Due to rapid quenching, that takes place at the exit of the furnace, carbon nanotubes are easily collected, in contrast to the batch processes mentioned earlier. The diameter and length of carbon nanotubes can be predetermined by controlling temperature in the furnace and quenching system, and also by adjusting the residence time within the furnace.

The microwave plasma apparatus of the present invention is the use of plasma made by the microwave radiation similar to the previous two inventions, U.S. Pat. No. 5,468,356 and U.S. Pat. No. 5,830,328 issued to Uhm, one of the present inventors, by making use of an intense electric field in the microwave radiations and use of the hot air in the torch flames of the present invention. The microwave plasma apparatus of the present invention has also a similar structure with the previous invention, U.S. Pat. No. 6,620,394 issued to Uhm, one of the present inventors, on Sep. 16, 2003. The microwave plasma apparatus of the present invention is directly connected to a furnace where the carbon nanotubes are synthesized. On the other hand, the previous three inventions are not concerned about a synthesis method or apparatus of carbon nanotubes.

It is therefore an important object of the present invention to enhance the electric field strength of the microwave radiation in order to achieve dissociation and ionization of synthesis materials in a carrier gas by exposure to a plasma torch generated by concentration of the microwave on a small spot.

Other object of the present invention is to provide an apparatus and a method for continuous and mass production of carbon nanotubes. The present invention works effectively for a wide range of carbon containing gases and transition metal catalysts or precursors with an atmospheric-pressure microwave plasma torch.

Another object is to overcome difficulties heretofore experienced in achieving continuous and mass production of carbon nanotubes.

Additional objects, and advantages and noble features of the invention will be explained in the description which follows, and in part will be apparent from the description, or will be learned by practice of the invention. The objectives and other advantages of the invention will be realized and obtained by the process and apparatus, particularly pointed out in the written description and claims hereof, as well as the appended drawings.

### BRIEF DESCRIPTION OF DRAWING FIGURES

A more complete appreciation of the invention and many of its attendant advantages will be aided by reference to the following detailed description in connection with the accompanying drawings:

FIG. 1 is a block diagram illustrating the carbon nanotube synthesis system of the present invention;

FIG. 2 is a side cross-sectional view of the reference number 100 in FIG. 1;

FIG. 3 is a typical Raman spectrum of carbon nanotubes grown by the microwave plasma torch using FT-Raman spectrometer.

### DETAILED DESCRIPTION

The present invention provides a synthesis method of carbon nanotubes, and more particularly to an apparatus for a mass synthesis of carbon nanotubes in gas phase using an atmospheric-pressure microwave plasma torch. The principles and operation of modular synthesis apparatus of the present invention are described according to the drawings.

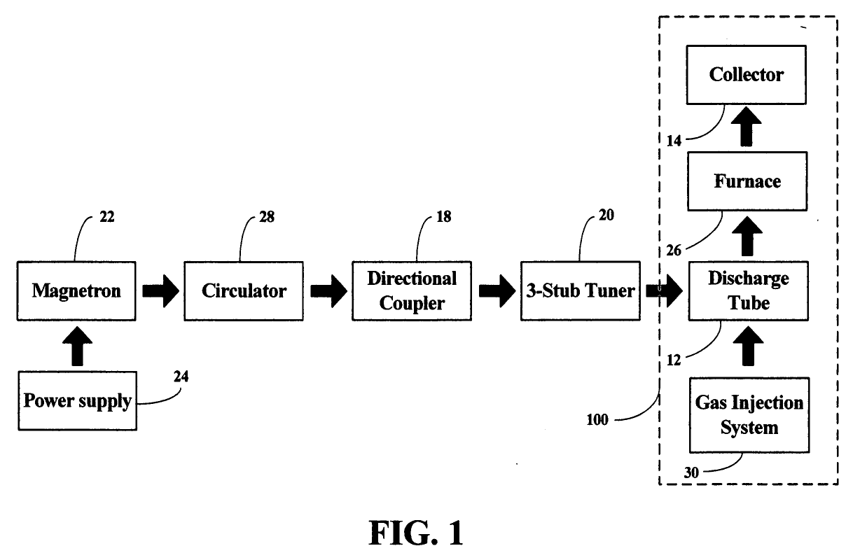

Referring now to the drawing in details, FIG. 1 diagrams the basic portion 100 of the present invention wherein a carrier gas containing metal catalyst precursor vaporized and optionally also a carbon-containing gas through a gas injection system 30 enters the discharge tube 12 made of an insulating dielectric material such as quartz or alumina. The gas injection system 30 has ports for the injection of a carrier gas and a swirl gas. According to the experimental results with various quartz size, it was found that the most suitable plasma generation accomplished when the inner diameter of the quartz tube with thickness 1.5 mm is in the range of 22˜30 mm for the microwave frequency of 2.45 GHz. Diameter of a typical plasma-torch flame is about 20 mm. The flame size does not increase even if the internal diameter of the quartz tube increases.

The power supply 24, consisted of full-wave voltage double circuit or DC power supply, provides the electrical power to the magnetron 22 which generates the microwave radiation and which is cooled by water or air. The magnetron 22 must be sufficiently cooled, because the magnetron efficiency is very sensitive to the temperature. The generated microwave radiation from the magnetron 22 is guided through the waveguide, passes through the circulator 28, the directional coupler 18, and the three-stub tuning device 20 in turn, and enters the discharge tube 12. The magnetron 22 in the present invention is the low-power 2.45 GHz microwave source used in a typical home microwave oven or continuously variable 2.45 GHz microwave generator having input power between 0.1˜6 kW. The electric field induced by the microwave radiation in the discharge tube 12 can be maximized by adjusting the three-stub tuning device 20. Also, the reflected power can be adjusted with the three-stub tuning device 20 to less than 1% of the forward power. Even with all the tuning stubs completely withdrawn, reflected power is typically less than 10%. The circulator 28 plays the role that absorbs the reflected power to protect the magnetron 22. The forward and reflected microwave powers are monitored through the directional coupler 18.

An ignition device with its terminal electrodes inside the discharge tube 12 is fired to initiate plasma generation inside the discharge tube 12. The plasma torch in discharge tube 12 is ignited by the combined action of the ignition device and the electrical power provided by the microwave radiation. The torch flame in the discharge tube 12 is stabilized by the swirl gas input. The swirl gas enters the discharge tube sideways creating a vortex inside the discharge tube 12, stabilizing the torch flame and protecting the discharge tube wall, made of quartz tube, from heat emitted by the flame of temperature with 5,000 degree Celsius. The swirl gas plays important roles in the thermal insulation of the discharge tube 12 and in the stabilization of the plasma torch flame. Therefore, a diluent gas for carbon-containing gas such as argon or nitrogen is injected as a swirl gas through the gas injection system 30. The carbon source gas may also be mixed with non-carbon source gases which play no direct role in the carbon nanotube forming reaction. The non-carbon source gas may play some secondary roles, for instance by reacting with amorphous carbon formed as a by-product and cleaning the reaction sites on the catalyst for carbon nanotube formation.

The discharge tube 12 is connected to a cylindrical furnace 26 comprising a heated refractory cylindrical wall allowing control of the temperature therein. Chemically active species produced in the plasma torch enter the furnace 26, which provides carbon nanotube forming environments such as residence time and temperature. With the exit of the furnace 26 is connected a collector 14 for carbon nanotubes, which is cooled by water and air for rapid quenching of carbon nanotubes.

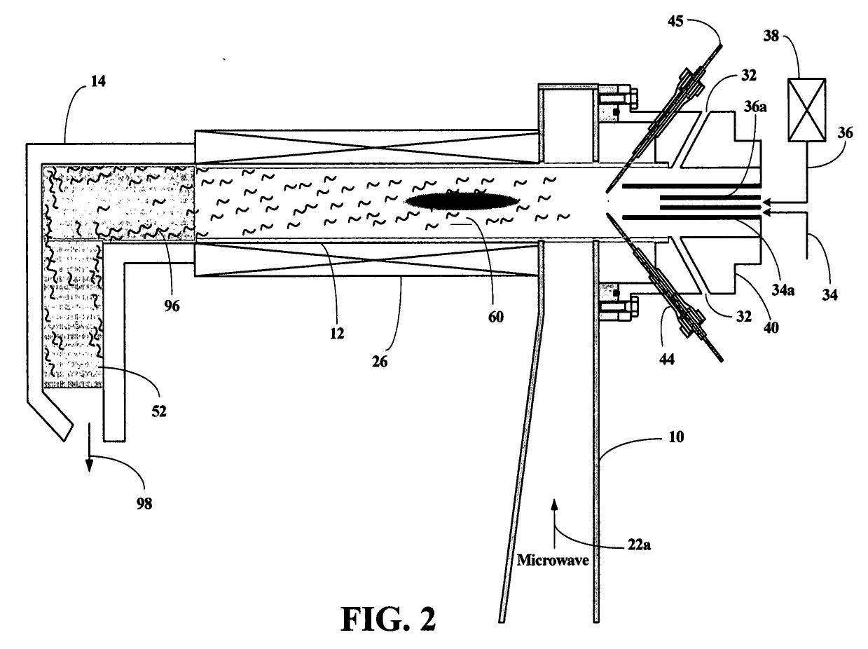

FIG. 2 shows a side cross-sectional view of the reference number 100 in FIG. 1. The swirl gas is injected through the swirl gas injection ports 32. The swirl gas enters the discharge tube sideways creating a vortex inside the discharge tube 12, stabilizing the torch flame and protecting the discharge tube wall. The discharge tube 12 is fixed by the quartz holder 40, which is made of stainless steel. The swirl gas is introduced through single inlet port or through multiple (e.g. two or four) inlet ports circumferentially arranged. The microwave 22 a radiated from the magnetron 22 propagates through a tapered waveguide section 10. The numerical reference 60 denotes the plasma torch flame generated by the breakdown of gas injected as a swirl gas in the strong electric field with the help of an ignition device 44. The ignitor 44 is retractable and consists of the tungsten electrode 45, which is insulated by an alumina tube. A carbon-containing gas 34 and a transition metal catalyst precursor 36 are introduced to the center of plasma torch flame 60 through introduction lines 34a and 36a, respectively. The transition metal catalyst precursor 36 is vaporized by an ultrasonication system 38 and is carried by an inert gas, for example argon. Moreover, the carbon-containing gas 34 and vaporized transition-metal catalyst precursor 36 is mixed and diluted by a swirl gas in the region of plasma flame 60. The diluent gas as a swirl gas plays no direct role in the carbon nanotube forming reaction but plays a contributory role, for instance by reacting with amorphous carbon formed as a by-product and cleaning the reaction sites on the catalyst for formation of carbon nanotubes. Alternatively, the swirl gas may be mixed and injected with hydrogen gas, which can help to etch away unwanted amorphous carbon.

Generally speaking, a carbon nanotube forming material 34 may be carbon monoxides, carbon particulates, normally liquid or gaseous hydrocarbons, or oxygen containing hydrocarbon derivatives. Suitable carbon containing compounds for use as the carbon source include carbon monoxides and hydrocarbons, including aromatic hydrocarbons, for example benzene, toluene, xylene, ethylbenzene, phenanthrene, non-aromatic hydrocarbons, for example methane, ethane, propane, butane, pentane, hexane, cyclohexane, ethylene, acetylene, and oxygen-containing hydrocarbons, for example acetone, methanol, ethanol, acetaldehyde or a mixture of two or more thereof. In preferred embodiments, the carbon-containing compound 34 is methane, ethylene or acetylene.

The catalyst or catalyst precursor 36 is suitably a transition metal catalyst or precursor. Particularly, preferred transition metal catalysts comprise Fe, Ni, Co, Mo or a mixture of two or more thereof. Any of these transition metals individually or in combination with any of the other transition metals listed may be used as a catalyst for carbon nanotube growth. The catalyst may be added as metal but is preferably a metal containing compound from which metal atoms are freed in the plasma torch flame 60. Such a precursor is preferably a plasma decomposable compound of one or more metals listed above. Preferably, the catalyst precursor is an organometallic compound comprising a transition metal, for example iron pentacarbonly.

The plasma torch generated by the electrical breakdown due to the microwave electric field dissociates and ionizes the carrier gas containing the carbon source gas 34 and a transition metal catalyst precursor vaporized 36 by molecular breakdown and by hot gases. The chemically active species produced in the plasma torch is utilized to initiate a chemical reaction. The interaction between the chemical species in the gas mixtures results in carbon nanotubes 96 by passing them through the furnace 26 with temperature in the range of 600 ˜1200° C. The furnace 26 provides the environment where carbons are progressively incorporated into growing nanotubes. The residence time in the furnace and its temperature will affect the diameter and the length of carbon nanotubes produced. The suitable temperature in the furnace 26 is in the range of 600˜1200° C. It may be uniform or may decrease toward the exit of the furnace 26. The introduced materials preferably have a residence time more or less 10 seconds within the furnace 26.

The carbon nanotubes 96 produced are quenched and subsequently collected in the stainless steel collector system 14 which houses a filter bag 52 to retain the carbon nanotubes 96 and allow the other gases 98 as by-product to emit through the exit of the collector system 14. Due to rapid quenching, that takes place at the collector system 14 connected with the exit of the furnace 26, carbon nanotubes 96 are easily collected, in contrast to the batch processes of the previously known methods. The diameter and length of carbon nanotubes are predetermined by controlling the temperature in the furnace and quenching system, and by adjusting the residence time in the furnace.

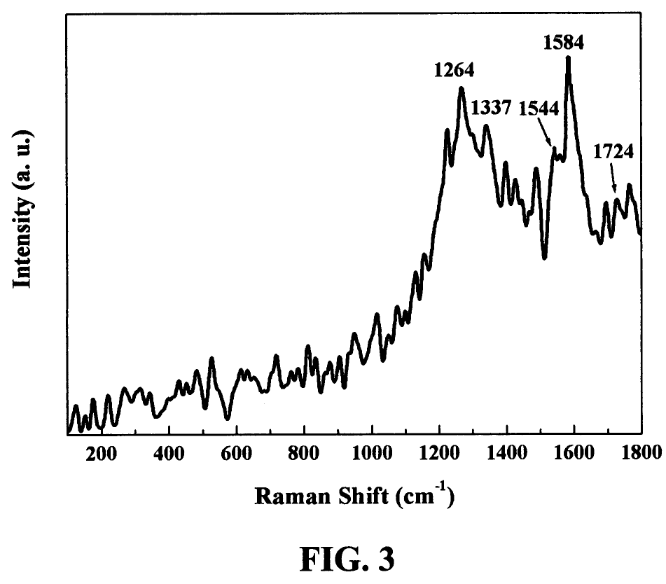

A sample of carbon nanotubes collected at the filter bag 52 was taken and was investigated by a scanning electron microscope (SEM). The SEM picture of the sample taken shows a bundle of curdled nanotubes. FIG. 3 shows a Raman spectrum of carbon nanotubes in a sample grown by the microwave plasma torch. This spectrum was taken by a FT-Raman spectrometer (BRUKER RES 100/S) with the excitation laser of Nd:YAG (wavelength: 1064 nm). The G line at 1584 cm⁻¹ is clearly shown in FIG. 3, which is a characteristic of graphite sheets. In addition to the G line, the side peak at 1544 cm⁻¹ indicates the existence of single-wall nanotubes with different diameters. The peaks ranging from 400 to 1000 cm⁻¹ are usually observed in single-wall nanotubes and could be related to the finite length of the carbon nanotubes. The peaks near 1264 cm⁻¹ indicate the existence of defective graphitic layers on the wall surfaces or carbonaceous particles due to the relatively low growth temperature.

### EXAMPLE 1

The apparatus used is shown in FIG. 2. Carbon nanotubes with the average diameter less than 80 nm and the average length of 1.5 micrometer were produced using argon as the swirl or diluent gas, acetylene as the carbon-containing gas, and iron pentacarbonyl as the transition metal precursor, which was carried by argon gas. The swirl gas flow rate was 15 liters per minute (lpm), that of acetylene was 100 standard cubic centimeters per minute (sccm), and that of the catalyst carrier gas was 50 sccm. Then the microwave forward power was 1.6 kW. The discharge tube of 30 mm diameter was used and the furnace length was 55 cm. The collector system and the furnace was maintained at 25° C. and 650˜700° C., respectively.

### EXAMPLE 2

The apparatus used is shown in FIG. 2. Carbon nanotubes with the average diameter less than 100 nm and the average length of 1 micrometer were produced using argon as the swirl or diluent gas, hexane as the carbon-containing gas, and iron pentacarbonyl as the transition metal precursor, which was carried by hexane gas. The swirl gas flow rate was 5 lpm and that of hexane was 1000 sccm. Then the microwave forward power was 1.2 kW. The discharge tube of 26 mm diameter was used and the furnace length was 55 cm. The collector system and the furnace was maintained at 25° C. and 650˜700 ° C., respectively.

### EXAMPLE 3

The apparatus used is shown in FIG. 2. Carbon nanotubes with the average diameter less than 100 nm and the average length of 1.5 micrometer were produced using nitrogen as the swirl or diluent gas, acetylene as the carbon-containing gas, and iron pentacarbonyl as the transition metal precursor, which was carried by argon gas. The swirl gas flow rate was 10 lpm and that of acetylene was 100 sccm, and that of the catalyst carrier gas was 50 sccm. Then the microwave forward power was 1.6 kW. The discharge tube of 30 mm diameter was used and the furnace length was 55 cm. The collector system and the furnace was maintained at 25° C. and 750˜800° C., respectively.

### EXAMPLE 4

The apparatus used is shown in FIG. 2. Carbon nanotubes were produced using nitrogen as the swirl or diluent gas, acetylene as the carbon-containing gas, and ferrocene dissolved in xylene as the transition metal precursor, which was carried by argon gas. The swirl gas flow rate was 15 lpm and that of acetylene was 100 sccm, and that of the catalyst carrier gas was 50 sccm. Then the microwave forward power was 1.6 kW. The discharge tube of 30 mm diameter was used and the furnace length was 55 cm. The collector system and the furnace was maintained at 25 ° C. and 650˜700° C., respectively.

Although this embodiment is the apparatus and method for the synthesis of carbon nanotubes, the invention is not limited to the use of the synthesis of carbon nanotubes. Without departing from the spirit of the invention, numerous other rearrangements, modifications and variations of the present invention are possible in light of the foregoing teachings. It is therefore to be understood that within the scope of the appended claims, the invention may be practiced otherwise than as specifically described.

1. An apparatus for continuous and mass synthesis of carbon nanotubes, said apparatus comprising:
(a) a discharge tube equipped with a microwave radiation generator for forming a microwave plasma torch with an ignition device and a multi-port gas injection system for injecting a carrier gas containing metal catalyst precursor vaporized and a carbon containing gas for forming carbon nanotubes;
(b) a furnace for passing the resulting gases mixture
(c) a collector system for quenching and collecting carbon nanotubes.

2. In the apparatus according to claim 1, wherein the said microwave plasma torch is capable of operating at 2.45 GHz and at power ranges of 0.1 to 6 kW with the assistance of auxiliary ignition systems.

3. In the apparatus according to claim 1, wherein the furnace is horizontally connected to the microwave plasma torch.

4. In the apparatus according to claim 1, wherein the furnace is 12˜22 inch long.

5. In the apparatus according to claim 1, wherein said gas injection system comprising a plurality of swirl gas inlets.

6. In the apparatus according to claim 1, wherein the furnace is capable of operating at temperature in the range of 600˜1200° C.

7. A process for continuous and mass synthesis of carbon nanotubes by introduction of microwave energy into an electric field to which carbon nanotube forming material is exposed, comprising:
(a) injecting a swirl gas as plasma or diluent gas into a dielectric discharge tube;
(b) creating an intense electric field in the swirl gas in the dielectric discharge tube by an incident and reflected electromagnetic wave generated by a magnetron and propagated through a tapered rectangular waveguide;
(c) forming an atmospheric-pressure plasma torch flame with the help of an ignition system in said electric field;
(d) introducing a vaporized metal catalyst or metal catalyst precursor and a carbon-containing gas into the center of the plasma torch flame;
(e) atomizing and ionizing carbon nanotube forming materials by molecular breakdowns and hot gases, and simultaneously mixing them with the swirl gas;
(f) passing the resulting gaseous mixtures through a furnace; and
(g) quenching and collecting carbon nanotubes in a collector system.

8. In the process according to claim 7, wherein the carbon nanotubes grow at a temperature of 600˜1200° C.

9. In the process according to claim 7, wherein the carbon nanotubes grow at one atmosphere.

10. In the process according to claim 7, wherein the transition metal catalyst is atomized at a pressure of 1 atmosphere.

11. In the process according to claim 7, wherein the carbon-containing gas is mixed and injected with the swirl gas.

12. In the process according to claim 7, wherein the metal catalyst or metal catalyst precursor is injected through one auxiliary inlet port or a plurality of inlet ports and is atomized at a temperature of 600˜1200° C.
